(19) United States
(12) Patent Application Publication
(10) Pub. No.: US 2012/0066128 A1
(43) Pub. Date: Mar. 15, 2012

(54) DATA COMMUNICATION METHOD AND SYSTEM FOR PROVIDING A FINANCIAL TRANSACTION

(75) Inventors: Marc Mumm, Munchen (DE); Rajasekharan Kuppuswamy, Munchen (DE)

(73) Assignee: VOICECASH IP GMBH, Zurich (CH)

(21) Appl. No.: 13/139,250

(22) PCT Filed: Dec. 12, 2008
(86) PCT No.: PCT/EP08/10598

§ 371 Date: Dec. 1, 2011

(51) Int. Cl. G06Q 40/00; H04W 12/06

(52) U.S. Cl. 705/44; 726/4

(57) ABSTRACT

Method for communicating data using a public mobile telecommunications or data network, to grant a remote user access to a safe financial transaction service, the method comprising inputting a voice sample of a user requesting access to the service at a mobile terminal, transmitting the voice sample data to a remote voice authorization server, which is directly linked to a transaction processing server governing a debitable and creditable user account, analyzing the voice sample data at the voice authorization server vis-a-vis pre-stored voice profile data, and outputting an access control signal granting or rejecting the request access, in response to the result of the analysis, to the transaction processing server.

The invention is related to a method for communicating data using a public mobile telecommunications or data network, to grant a remote user access to a safe financial transaction service and a corresponding data communication system. Credit cards are a well-known and wide-spread means for initiating financial transactions and are used worldwide. Recently, besides the credit cards, meanwhile being a traditional payment instrument, prepaid cards have won market shares in the field of financial transactions, due to their simplified security requirements and organization schemes.

However, in many regions of the world, and in particular in developing countries with a comparatively poor banking infrastructure, even simple financial transactions may still be difficult, time consuming and costly and not easily accessible for everybody.

Although the development of online transactions has, at least to a certain extent, improved the situation for people in developing countries in this regard, the combined use of “classic” and online transaction schemes results in a number of problems and disadvantages.

The growing number of credit card fraud, phishing and pharming attacks limits the willingness of customers to use credit cards both online and offline. More and more users are not willing to enter their credit card information on websites as they are afraid of becoming victims of ID and credit card fraud. Thefts would have immediate access to their credit card account, whereas the fraud is limited by the credit limit of the card.

Besides online fraud, happening after having entered credit card details online, additionally, cards can get lost, get stolen or any other kind of fraud can happen. This is a general disadvantage of any kind of physical card, known since long ago, but not yet satisfactory resolved.

In the last few years, therefore, several schemes for generating and using online-based derivatives of regular credit cards have been published and, at least to some extent, introduced in Internet payment procedures. However, although these attempts provide a number of advantages and under certain aspects look promising, they suffer from problems regarding the complexity of required procedures and/or the fulfilment of security requirements.

Therefore, it is an object of the present invention to provide an improved data communication method and system for providing financial transactions, which in particular fulfil the current requirements of easy accessibility to users in countries without a highly developed banking infrastructure, of a reasonable standard of reliability and security and of easy handling and short transaction times.

This object is solved by a method according to claim 1 and a system according to claim 10.

A system for various kinds of electronic transactions and linked modules and operations is proposed. The transactions and operations are preferable initiated by a mobile phone. The preferred underlying payment instruments which can be accessed and operated via the mobile phone are (a) a prepaid credit card and (b) a mobile wallet.

A prepaid credit card has the same functionality like a standard credit card, however only money available on the card can be used for spending or cash withdrawal. The context in which the prepaid credit card is used in this context is as a double card pack. The cards can be in possession of different persons and money can be transferred from user A's prepaid credit card to user B's prepaid credit card.

A mobile wallet is a virtual bank account which is linked to the mobile phone. A mobile wallet has the same functionalities like a normal bank account; however it can be restricted in terms of usage to adapt it to specific needs, e. g. money can be transferred among registered users, on only certain operations like transferring money or adding money are possible—not all standard operations like with a standard bank account could be available. Normally, a mobile wallet can be accessed via the mobile phone and offers certain payment options to the user.

However the range of payment instruments which can be linked to the platform is not restricted. Other options are e. g. virtual prepaid credit card, bank account or credit card.

It is an essential aspect of the invention that a user requesting access to the financial transaction service provides a voice sample and that this voice sample is processed in a remote voice authorisation server to identify the user and to authorise a transaction which is carried out upon his request. This identification of the user is obtained in the result of an analysis of the transmitted voice sample data vis-a-vis pre-stored voice profile data of registered users. As a “physical” result of this analysis, an access control signal is generated which, depending on the positive or negative result of the comparative analysis, directly controls that the alleged user's access to the transaction system is granted or rejected, respectively.

In an embodiment the access control signal is generated exclusively on the basis of the voice sample transmitted via the mobile telecommunications network, without involving supplementary authentication channels. As for as in this embodiment the predetermined security requirements can be fulfilled, it is particularly advantageous because of its simplicity for almost any user worldwide. Voice verification is language independent and also usable as a security technology for illiterates. Furthermore, the implementation of this embodiment and any extension to new regions or broader user circles is very simple and does not require a developed logistic infrastructure.

Likewise, a further embodiment, in which the access control signal is used to grant direct and immediate access to the user account, without involving a supplementary security scheme implemented at the transaction processing server, is easy to implement and operate for the provider and easy to handle for the user. Nevertheless, should the security level of this simple embodiment turn out to be not sufficient under certain conditions, a password or PIN scheme may be added to the core voice authentication scheme, in a modular manner.

In a further embodiment, a selection of admitted types of messages is pre-defined, each type of message being uniquely assigned to a certain type of financial transaction and being identified by a message or data packet header. In this way, a standardized and highly fault-tolerant data transmission scheme is established which, at the user's end, may contain a soft key operation in the frame work of a simple dedicated user interface. In a particularly advantageous embodiment, an admitted type of message is provided, which comprises payment or cash withdrawal channel data specifying a transaction channel, which does not terminate at the terminal from which the respective message originates or at the user account of the authenticated user from whom of the message originates. In this way, it becomes possible to initiate a money transfer from one user to another one in a very simple and fast manner, even if the receiving user is not a registered user of the system.

In a further embodiment, related to the above embodiments, the pre-defined messages are sent from a mobile terminal in the SMS or USSD format, and the reception and processing of a respective message at the voice authorization server triggers a callback procedure with the mobile terminal from which the message originates or with a registered mobile phone of the identified user, which has sent the message, via a voice channel of the mobile telecommunications network. Further xHTML or Jawa files may be transmitted via GPRS or other transfer protocols, or even a voice file may be transmitted to the authorization server and further be processed there.

The reasons why Text SMS is chosen as the preferred starting channel is that from the user point of view nothing needs to be installed on the device and no changes in the usage are required. Access via USSD is similar to SMS, and uses the same signaling channel, but provides a session dialogue to exchange short text messages. For services bases on Java or xHTML additional software has to run on the mobile device or needs to be installed. From the user point of view either a command via SMS needs to be entered or a similar initiation action via any of the described channels. The command is transported via the chosen channel to a communication gateway. This can either be a SMS Gateway, a webserver or any of the above described communication gateways linked with the “Communication Switch”.

In a further embodiment, the user account is arranged to be credited and/or debited exclusively via a mobile telecommunications network, in particular via messages originating from predetermined mobile terminals, each being identified by a MSISDN or similar user terminal ID and registered at the authorization server in advance of an access to the service. In this embodiment, the system is specifically dedicated to an access via mobile telecommunications networks which, due to their specific registration and security schemes, offer a higher security level than open computer networks. Insofar, a system according to this embodiment may have a simpler configuration and higher security level, compared to “mixed access” systems.

However, in a modified embodiment both a mobile telecommunications access and a wired data network access may be provided by a modular combination of dedicated interfaces with specific access and identification/security schemes.

In a further embodiment, an electronic reference ID is assigned to the user account, the reference ID being linked to at least one predetermined MSISDN or similar user terminal ID, the link comprising a type of service ID indicating which type of message, each type indicating a certain type of transaction, originating from a certain user terminal will be accepted at the transaction processing server. In a further embodiment, the user account is arranged to be loaded via channels outside the public mobile telecommunications network, in particular via a nonpublic retail network or a bank transfer or credit card transfer channel. Depending on the available financial transaction infrastructure, the users may select a convenient channel on a permanent or temporary basis as the required interfaces or “switches” to the banking infrastructure are provided in the system.

System aspects of the invention may easily be derived from the above explained method aspects, so that a repeated explanation shell be avoided.

Further aspects and advantages of the invention become clear form the following description of embodiments, as shown in the FIGURE.

FIG. 1 shows a functional block diagram of an embodiment of the inventive system.

Important modules of the system are:

Data Communication Switch

The data communication switch is the interface to the user. Via various channels the user can communicate with the central server. All of the access channels from the user point of view are preferably mobile based. Amongst others, SMS, Mobile Internet, MMS, Active Call, IP/Data Channel respectively USSD can be used.

The data communication switch is also taking care of identifying the user. This can either be done through transmitted information like MSISDN or through the input of the user, e.g. via DTMF or voice recognition. The data communication switch is closely linked to all other switches and servers as it is used as the first input module and last output module.

Authorization Server

The authorization server is taking care of verifying a transaction or operational command initiated by the user. Therefore the server has a creation, computing and comparison part. E.g. a PIN entered by the user through SMS will be checked by the authorization server if it matched the once issued or stored PIN. The preferred use case for the authorization server is verification via voice biometrics.

Data Creation and Receiving Switch

The data creation and receiving switch is the main communication switch for all operations done by external partners and not directly operated in the system. This switch takes case that data provided by the system are communicated to the right partners via the right interface and also that data received by external partners are processed by the right modules within the system.

User Data Profile Storage

The user data profile storage is the main storage for all details linked to the user, like personal data, mobile phone number or E-Mail address. If the system is certified according to financial standards like PCI it is also possible to store data related to financial instruments like credit card details or account details in the user data profile storage.

Payment Transaction and Processing Switch

A payment transaction and processing switch is handling the transaction or operation itself. A transaction initiated by a user has consequences related to the user's underlying payment instruments like prepaid credit card or mobile wallet. The switch is initiating this transaction, processing it, giving information about required changes in the underlying payment instruments and if needed also initiates a request to the data creation and receiving switch to involve external partners.

In the following, the registration of the user from the user point of view and from the technical point of view will be described.

1^{st} Step: Registration of the User.

In all scenarios the user needs to sign up for the service by providing a certain set of personal information like first name, last name, address, data of birth, E-Mail address or mobile phone number. The user can enter these data either online, at a merchant or via the mobile phone. The input of the user is stored in the system. (“User Data Profile Storage”) The set of information which needs to be provided is mainly dependent on country-specific banking and financial regulations and compliance issues.

In the case of a mobile wallet upon registration, the information of the user stored in the system is processed via an interface to the banking partner (“Banks and Issuing Partners”). A virtual bank account is created for the user, an account ID or any kind of reference ID which is matching the created virtual account with the user data stored in the system is sent from the banking partner back to the system. Dependent in the level of PCI certification of the system, either the full financial data of the mobile wallet or only a reference id will be stored in the system.

In the case of a prepaid credit card upon registration, the information of the user collected by the system ID processed via an interface to the processing partner (“Processor”). The processor is creating a prepaid credit card account and provides the system with a card-ID or any kind of reference ID which is matching the created prepaid credit card with the user data stored in the system. Dependent on the level of PCI certification of the system, either the full financial data of the prepaid credit card or only a reference ID will be stored in the system.

In both cases it is also possible that the module “Banking and Issuing Partners” and “Processor” is part of the system itself and no external partners have to be involved.

After this process is successfully finished, the user will be informed about the creation of his profile/account and can use the system after this. In the case of the prepaid credit card a card is issued for the user and sent to his home address.

2^{nd} Step: Adding Money to the System

In a second step the user needs to add money to the underlying payment instrument (in the preferable use case the prepaid credit card or the mobile wallet). In the preferred scenario the user can only use the payment instrument after money has been added to the account (prepaid). It is also possible that the user can use the payment instrument without having added money to it in advance (postpaid). However this is linked to a certain level of credit risk.

There are multiple options to add money to the payment instrument. The most preferred ones are:
Cash Network (Retail network accepting cash from the user)
Credit Card/Debit Card
Bank Transfer

Also additional loading methods might be enabled in the future to maximize the accessibility of the service.

3^{rd} Step: Using the System

Money available in the payment instrument can be accessed and used by the registered user.

Access to the System:

To access and operate his payment instrument/account in the system, the user has different options, most preferable a mobile device. Details are described further above.

Identification and Data Check:

The command inputted on the device as well as the user identification (either via MSISDN, touchtone or any other identifiers) are identified by the system. After this the system initiates a session with multiple modules of the system (“Authorization-Server”, “Data creation and receiving switch”, “User Data Profile Storage”, “Payment Transaction & Processing Switch”). The system can check the status of the user, his account and other related issues in the system.

Verification:

If all checks are positive, a signal is send to the authorization server to initiate an authorization call. The user is called back on the mobile phone number registered in the system/transmitted via MSISDN and has to verify the initiated command to the system. The verification is done in the preferred version of the system via voice verification. A preregistered voice profile will be matched to a live voice input of the user.

The first registration can either be done during/after online registration or along with the first transaction in order to minimize the number of calls needed for fully registering the user. If the enrolment is done during the first transaction a verification code or, in an alternative, a PIN will be provided to the user (or chosen by the user) after the registration. This verification code has to be entered by the user during the first transaction in order to verify his identity. The user can then decide to continue using the verification code for future transaction or to enable his account with voice biometrics.

The preferred process via SMS/Callback has multiple advantages versus already established methods. The MSISDN is transmitted via the SMS; therefore the user can automatically be identified. The SMS and the related command is sent via the data channel, however the callback is done via the voice channel, a two channel security is established. Although if e.g. the data channel is hacked or a SMS is sent with a faked MSISDN the callback will come to the real telephone number and the user can still prevent the transaction by denying it during the callback. However in some scenarios it also makes sense to do verification in the same step which is used to initiate the transaction. Therefore the user needs to enter a security code or another verification number which can clearly be matched to the user during the initiation, e.g. by typing a PIN in the SMS. This verification could also be done during an active call.

Transaction Processing:

Once the user went through a positive verification the transaction is processed in the system. This is mainly done by the “Payment Transaction & Processing Switch”. Account details of the user (if stored in the system) are updated, e.g. money is debited from one prepaid credit card account and credited to another prepaid credit card account, or money is debited from a user's mobile wallet and credited to another user's mobile wallet or spent with linked services after being debited. It is possible and intended to link mobile services, such as airtime top-up or cash payment of mobile telecommunication services at merchants to the default system. Therefore, besides mobile money transfer, the further transaction of the debiting of the payment instrument and spending of the debited money for a linked service will be available, in an embodiment of the invention.

If these data/financial instruments are not stored in the system, the system connects via the “Data creation and receiving switch” to external partners like banks, processors or Payment Service Providers. These partners process the transactions and send a feedback about the result via a defined interface to the system. This result could e.g. be a successful batch initiation to the credit card network or sending the balance of a user's prepaid credit card.

1.-14. (canceled)

15. A method for communicating data, using a public mobile telecommunications or data network, to grant a remote user access to a safe financial transaction service, comprising:
receiving, at a voice authorization server, voice sample data of a user requesting access to the service at a mobile device, the voice authorization server remote from the mobile device and directly linked to a transaction processing server that governs a debitable and creditable user account;
analyzing the voice sample data at the voice authorization server vis-a-vis pre-stored voice profile data; and
outputting to the transaction processing server, as a result of the analysis, an access control signal granting or rejecting the user requested access.

16. The method of claim 15 wherein the voice sample data is received via the mobile telecommunications or data network and the access control signal is generated exclusively on the basis of the received voice sample data transmitted via the network without involving supplementary authentication channels.

17. The method of claim 15 wherein the access control signal is used to grant direct and immediate access to the user account without involving a supplementary security scheme implemented by the transaction processing server.

18. The method of claim 15 wherein the user account is arranged to be credited and/or debited exclusively via the mobile telecommunications or data network by receiving messages originating from predetermined mobile devices, each device being identified by a MSISDN or device identifier and registered at the authorization server in advance of an access to the service.

19. The method of claim 18 wherein an electronic reference identifier is assigned to the user account, the reference identifier being linked to at least one predetermined MSISDN or device identifier, the link comprising a type of service identifier indicating a type of message, each type indicating a type of transaction, originating from a particular device, that will be accepted at the transaction processing server.

20. The method of claim 18 wherein a selection of admitted types of the messages and/or user requests are predefined, each type of admitted message or user request being uniquely assigned to a type of financial transaction and being identified by a message or data packet header.

21. The method of claim 20 wherein an admitted type of message is provided that comprises payment or cash withdrawal channel data specifying a transaction channel, wherein the channel does not terminate at the device from which the respective message originates or at the user account of the authenticated user from whom the message originates.

22. The method of claim 21 wherein the admitted type of message that comprises payment or cash withdrawal channel data is used to transfer money to another user.

23. The method of claim 22 wherein the another user is a user not registered with the voice authorization server.

24. The method of claim 18 wherein the messages are in SMS or USSD format, and wherein the receiving of a respective message at the voice authorization server triggers a callback procedure to the mobile device from which the message originated or to a registered mobile device of the requesting user, via a voice channel of the mobile telecommunications or data network.

25. The method of claim 15 wherein the user account is arranged to be loaded using a channel outside the public mobile telecommunications or data network, including one or more of a non-public retail network channel, a bank transfer channel, and/or a credit card transfer channel.

26. A data communication system comprising:
a voice and data communication interface configured to connect the data communication system with a public mobile telecommunications network to which mobile devices of system users are connected;
a voice authorization server configured to receive voice sample data and a messages originating from the mobile devices of system users and to process voice-based identification and authentication data of the users and to generate access control signals to grant or reject a corresponding requested access to a financial transaction service,
a user profile data base configured to store user-related data required to identify a user and financial transaction instruments linked to a specific user, and configured to store admitted message types referring to specified financial transaction instruments, and
a transaction processing server configured to handle financial transaction processing in response to receiving content of a message of an admitted type and a positive access control signal documenting a requested financial transaction.

27. The system of claim 26 wherein the voice and data communication interface is configured to receive and process messages in SMS, USSD, and/or other mobile telecommunications standard formats, and to handle callback procedures via a mobile telecommunications network voice channel in response thereto, including obtaining and forwarding voice sample data to the voice authorization server.

28. The system of claim 26 wherein the voice and data communication interface is configured to receive and process MSISDN or other device identifiers via the public mobile telecommunications network and internal reference identifiers, in cooperation with the user profile data base, as well as for recognizing and specifically forwarding admitted types of messages from outside to the transaction processing server and vice versa.

29. The system of claim 26, further comprising:
a data receiving and delivering switch configured to connect the data communication system to external transaction partner systems using data accumulation and data format conversion schemes specific to the partner systems.

30. The system of claim 26 wherein the data and voice communication interface is directly connected to the transaction processing server, and wherein the interface and the server are configured such that financial transaction data content contained in corresponding messages from the mobile devices of the system users are forwarded directly to the transaction processing server for processing upon receiving a corresponding access control signal issued by the authorization server in response to positive authentication of the user requesting access via the corresponding message.

31. The system of claim 26 wherein the voice authorization server is further configured to callback to a mobile device of a user that is requesting access to the financial transaction service, or to a registered mobile device associated with the user, when an access control signal is granted.

32. The system of claim 26 wherein the voice authorization server is configured to receive a type of message that comprises payment or cash withdrawal channel data that is used to transfer money to another user.

33. The system of claim 32 wherein the another user is a user not registered with the data communication system.
